(19) United States
(12) Patent Application Publication
(10) Pub. No.: US 2014/0019536 A1
(43) Pub. Date: Jan. 16, 2014

(54) REALTIME COLLABORATION SYSTEM TO EVALUATE JOIN CONDITIONS OF POTENTIAL PARTICIPANTS

(71) Applicants: James E. Christensen, Cortlandt Manor, NY (US); David S. Marshak, Wrentham, MA (US); Andrew L. Schirmer, Andover, MA (US); Amy D. Travis, Arlington, MA (US)

(72) Inventors: James E. Christensen, Cortlandt Manor, NY (US); David S. Marshak, Wrentham, MA (US); Andrew L. Schirmer, Andover, MA (US); Amy D. Travis, Arlington, MA (US)

(73) Assignee: International Business Machines Corporation, Armonk, NY (US)

(21) Appl. No.: 13/547,307

(22) Filed: Jul. 12, 2012

(51) Int. Cl. G06F 15/16

(52) U.S. Cl. 709/204

(57) ABSTRACT

A real-time collaboration system receives a join condition of a potential participant of a real-time collaboration session. The join condition requires that a selected individual has connected to the real-time collaboration session and that the selected individual is prepared for participation in media sharing during the real-time collaboration session, or that selected information has been expressed during the real-time collaboration session, or that the potential participant has finished a task that overlaps in time with the real-time collaboration session, or that a selected number of individuals necessary to establish a quorum have connected to the real-time collaboration session, or that a selected individual has disconnected from the real-time collaboration session. If the real-time collaboration system determines that the join condition has been satisfied, then the real-time collaboration system notifies the potential participant to join the real-time collaboration session.

### FIELD OF THE INVENTION

The present invention relates generally to real-time collaboration systems, and more particularly to real-time collaboration systems that notify a potential participant when a join condition has been satisfied.

### BACKGROUND

The use of virtual meetings of many types has increased greatly, given the recent proliferation of communication technologies, and given the relatively higher costs of conducting in-person meetings. Typically virtual meetings, which can include group chat rooms, webinars, conference calls (also referred to herein as “teleconferences”), and the like, are assemblies of individuals for a business or social purpose conducted using a communication medium such as the Internet or another network, and hosted by a real-time collaboration system. Teleconferences can be used for personnel training, presentations, or for business organization, for example. During a teleconference, each participant can use his or her own computer or telephone to be connected to all other participants via the network, and can participate in the sharing and exchange of audio or video information. Sharing and exchange of information can be facilitated with techniques such as virtual whiteboarding, shared work spaces, slideshow presentations, streaming video, web tours, meeting recording capabilities, simultaneous text chat, polling, surveys, screen sharing, desktop sharing, and application sharing. In many instances, a teleconference is provided or hosted by a server computer operating as a real-time collaboration system.

When a teleconference is scheduled for a specific date and time, current solutions provide ways to remind a participant of the teleconference. For example, some current electronic calendaring systems will send an email notification in advance of a teleconference on the electronic calendar. This form of reminder is useful, but the participant still has to manually call into the teleconference and enter his or her user credentials to join the teleconference. Some current solutions have gone a step further, and can call a participant at the beginning of a scheduled teleconference to expedite the process of joining the participant to the teleconference. Further still, some current teleconference systems can call a participant based on a predetermined, static condition such as a predetermined time, or such as when a moderator joins the teleconference, or such as when a participant clicks through a preset point in a pre-established agenda. Nonetheless, these current solutions still suffer from many drawbacks, and it is common for teleconference participants to call in and waste time waiting for others, or to call in at an inappropriate time, or to fail to call in when their presence would be beneficial.

### SUMMARY

Embodiments of the present invention provide for a program product, system, and method in which a potential participant is notified to join a real-time collaboration session. A real-time collaboration system receives a join condition of a potential participant. The join condition requires that a selected individual has connected to the real-time collaboration session and that the selected individual is prepared for participation in media sharing during the real-time collaboration session, or that selected information has been expressed during the real-time collaboration session, or that the potential participant has finished a task that overlaps in time with the real-time collaboration session, or that a selected number of individuals necessary to establish a quorum has connected to the real-time collaboration session, or that a selected individual has disconnected from the real-time collaboration session. If the real-time collaboration system determines that the join condition has been satisfied, then the real-time collaboration system notifies the potential participant to join the real-time collaboration session.

### BRIEF DESCRIPTION OF THE SEVERAL VIEWS OF THE DRAWINGS

FIG. 1 is a functional block diagram of real-time collaboration system 100 in accordance with an embodiment of the present invention.

FIG. 2 is a functional block diagram of teleconference server 120 of real-time collaboration system 100 of FIG. 1 in accordance with an embodiment of the present invention.

FIG. 3 is a flowchart depicting the steps followed by teleconference server 120 to establish teleconference sessions and evaluate join conditions in accordance with an embodiment of the present invention.

FIG. 4 is a block diagram of hardware and software within teleconference server 120 and computers 116 of real-time collaboration system 100 of FIG. 1 in accordance with an embodiment of the present invention.

### DETAILED DESCRIPTION

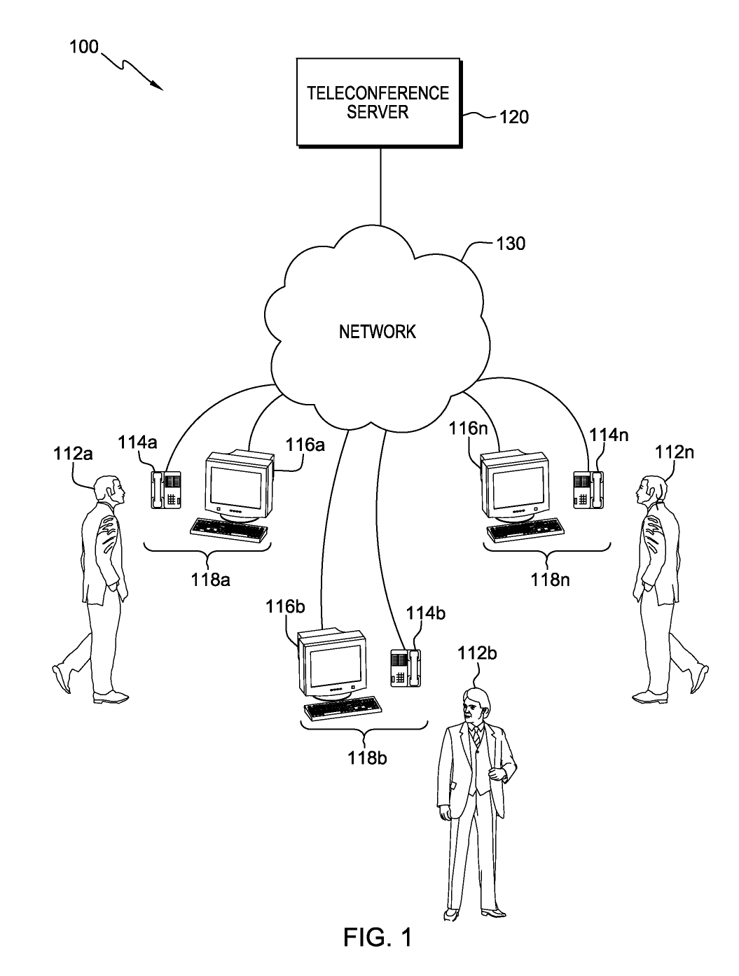

FIG. 1 depicts a functional block diagram of real-time collaboration system 100 in accordance with an illustrative embodiment of the present invention. Real-time collaboration system 100 includes teleconference server 120; network 130; telephones 114a, 114b, and 114n; and computers 116a, 116b, and 116n. Telephones 114a, 114b, and 114n, also referred to herein as telephones 114a through 114n, include any number of n telephones, where n is greater than one. Computers 116a, 116b, and 116n, also referred to herein as computers 116a through 116n, includes any number of n computers, where n is greater than one. In some embodiments, the number of n computers is different than the number of n telephones. It should be understood that teleconference server 120 of real-time collaboration system 100 is not limited to providing teleconference sessions, but instead in various embodiments teleconference server 120 can provide a variety of real-time collaboration services besides, or in addition to, teleconference sessions, such as virtual meetings, group chat sessions, online collaboration sessions, video conferences sessions, and so on.

Each depicted pairing of a telephone and a computer (for example, telephone 114a and computer 116a) is regarded as a teleconference endpoint 118 within real-time collaboration system 100. Teleconference endpoints 118a, 118b, and 118n, also referred to herein as teleconference endpoints 118a through 118n, are each operable by a respective person 112 (for example, teleconference endpoint 118b is operable by person 112b). Although FIG. 1 depicts each teleconference endpoint 118 as including a pairing of a telephone 114 and a computer 116, in other embodiments, a teleconference endpoint 118 may include only a telephone 114 or only a computer 116.

Network 130 provides connectivity among teleconference endpoints 118a through 118n and teleconference server 120 by enabling the transport and control of communications signals during a teleconference. The communications signals convey digital media or analog media, such as audio media and video media, for example. Toward this end, network 130 can include one or more interconnected data-processing systems such as switches, servers, routers, gateways, private-branch exchanges, and teleconference bridges. In one embodiment, one or more of teleconference endpoints 118a through 118n may be tied to a private branch exchange of network 130. In one embodiment, one or more of teleconference endpoints 118a through 118n may interact via common audio channels, common media channels, or both, managed by teleconference server 120 via network 130. Network 130 can include or utilize the Internet and can utilize wired or wireline communications techniques. In general, network 130 can be any combination of connections and protocols that will support communications between teleconference server 120 and one or more teleconference endpoints 118a through 118n in accordance with embodiments of the present invention.

Each of teleconference endpoints 118a through 118n can include a cellular phone, a conference phone, a speaker phone, a desk set, a computer with a resident software phone, or any other type of telecommunication device that can exchange voice signals. Teleconference endpoints 118a through 118n are each able to transmit and receive voice signals to and from (in other words, are each able to call and be called by) the other members of teleconference endpoints 118a through 118n. For example, telephones 114a through 114n are each able to call, or be called by, the other members of telephones 114a through 114n. Further, each of teleconference endpoints 118a through 118n can include a personal computer, a laptop, a personal digital assistant, a thin client, or any other type of computer that can exchange and process data. In various embodiments, the entire functionality of a teleconference endpoint 118 can be implemented in multiple devices or in one device. In the latter case, the entire functionality of a teleconference endpoint 118 might be implemented solely in its telephone 114, or solely in its computer 116, for example.

Computers 116a through 116n each include calendaring software that is interoperable with teleconference server 120 at least for the purpose of scheduling teleconferences. For example, in one embodiment computer 116a includes calendaring software that person 112a can use to select a date and time for a teleconference, and to send invitations or notifications to persons 112b and 112n, also referred to herein as persons 112b through 112n, that inform them of the teleconference and request their participation. In one embodiment, the selected date and time can be immediate, such that the teleconference is an ad hoc teleconference. Person 112a can further use the calendaring software of computer 116a to reschedule the teleconference, to invite new participants to the teleconference, to revoke the invitations of participants from the teleconference, or to cancel the teleconference, for example. Further, similar calendaring software can be included in computers 116b through 116n that allows persons 112b through 112n, respectively, to reschedule or otherwise modify the scheduled teleconference. In one embodiment, the calendaring software is provided or installed independently of teleconference server 120, while in another embodiment the calendaring software is provided by teleconference server 120 to computers 116a through 116n via a web interface, for example. In one embodiment, teleconference server 120 can itself send and manage invitations.

Teleconference server 120 receives the teleconference scheduling information from the calendaring software of computers 116a through 116n, and then on the scheduled date and time establishes teleconferences for the appropriate participants. The teleconference can be established immediately if it is an ad hoc teleconference. For example, in one embodiment, to establish a teleconference for persons 112a through 112n, teleconference server 120 can make available a common audio channel to telephones 114a through 114n, which persons 112a through 112n utilize by dialing a single phone number associated with teleconference server 120 or associated with the scheduled teleconference. In another embodiment teleconference server 120 can establish a teleconference for persons 112a through 112n by making available a common audio channel to computers 116a through 116n, which persons 112a through 112n utilize by activating teleconference client software associated with teleconference server 120. In other embodiments, teleconference server 120 can establish a teleconference for persons 112a through 112n by opening a common audio channel among telephones 114a through 114n by automatically dialing telephones 114a through 114n, or by automatically activating teleconference client software of computers 116a through 116n. In addition to providing a common audio channel to the teleconference participants, teleconference server 120 can also provide a common media channel, such as a common visual channel to facilitate screen or slide sharing by computers 116a through 116n, for example. Further, in one embodiment, teleconference server 120 can provide a common data channel that combines audio, media, and other information into a single common channel.

In addition to establishing teleconferences on the scheduled date and time for the appropriate participants as discussed above, teleconference server 120 can also evaluate join conditions before and during a teleconference session. The phrase “join condition,” as used in this specification, refers to a condition that must be satisfied prior to joining a person as a participant to a teleconference. Accordingly, a person whose participation in a teleconference is contingent on the outcome of a join condition evaluation can be referred to herein as a “potential participant” of the teleconference he or she may join if the join condition is satisfied. In one embodiment, after scheduling a teleconference utilizing the calendaring software of computer 116a, person 112a can establish a join condition for the scheduled teleconference utilizing join condition software on computer 116a. Person 112a can thus be regarded as a potential participant in the teleconference he or she personally scheduled. In another embodiment, after accepting an invitation to a teleconference utilizing the calendaring software of computer 116b, person 112b can establish a join condition for the scheduled teleconference utilizing join condition software on computer 116b. Person 112b can thus be regarded as a potential participant in the teleconference person 112a scheduled. In both embodiments, once established on one of computers 116a through 116n, a join condition is sent to teleconference server 120 via network 130 for evaluation. In one embodiment, the join condition software is provided or installed independently of teleconference server 120, while in another embodiment the join condition software is provided by teleconference server 120 to computers 116a through 116n via a web interface, for example.

When a join condition evaluation results in a determination that the one or more join conditions have been satisfied, the potential participant can be joined as a participant to the teleconference in several ways. For example, teleconference server 120 can join the potential participant to the teleconference by calling telephone 114 of the potential participant, or by sending the potential participant an email or other electronic notification that the join condition has been satisfied on his or her computer 116.

Join conditions can be customized by persons 112 in accordance with a desired embodiment of the present invention and can involve a variety of criteria. Similarly, evaluation of those join conditions can involve examining a variety of criteria, such as, for example, the environment of the potential participant or aspects of the scheduled or ongoing teleconference. A variety of join conditions are discussed below, and one or more of the following join conditions can be implemented in any given embodiment.

In one embodiment, a potential participant, such as person 112b, can establish a join condition requiring that a selected number of individuals necessary to establish a quorum has connected to a teleconference session before person 112b is joined to the teleconference session. For example, a quorum can be defined in the join condition as a majority of company officers or directors who have been invited to the teleconference session, some number greater than that majority, or some number less than that majority. Further, a quorum can be defined in the join condition as a majority of the total participants who have been invited to the teleconference session, some number greater than that majority, or some number less than that majority. To evaluate the join condition, during the teleconference, teleconference server 120 can periodically count the total number of participants who have joined the teleconference, or count the number of company officers or directors who have joined the teleconference. In the former case, the total number of participants can be calculated by teleconference server 120 based on the number of active connections from teleconference endpoints 118, for example. In the latter case teleconference server 120 can be configured to have access to a personnel directory or organizational chart, to determine which participants in the teleconference are company officers or directors and to calculate their total number. Alternatively, in the latter case teleconference server 120 can learn which participants in the teleconference are company officers or directors from person 112a who set up the teleconference, for example, or from a status indication in each participant's invitation acceptance or rejection. After the counted number of company officers or directors or of total participants reaches or exceeds the defined quorum level, then the join condition has been satisfied and the potential participant is joined to the teleconference.

In another embodiment, a potential participant, such as person 112b, can establish a join condition requiring that a selected individual has disconnected from a teleconference session before person 112b is joined to the teleconference session. For example, the selected individual can be an individual named by person 112b in the join condition. The selected individual might be selected because, for example, person 112b and the selected individual have a personality conflict, or because person 112b would like to discuss or share in the teleconference information that the selected individual is not authorized to hear or see, or because person 112b knows that the selected individual already knows about the information person 112b would like to discuss or share and thus does not need to be presented with the information again, or for a variety of other reasons. In one embodiment, teleconference server 120 can evaluate the join condition as having been satisfied if the selected individual has connected to the teleconference and then disconnected. In another embodiment, teleconference server 120 can evaluate the join condition as having been satisfied if the selected individual has not been invited to the teleconference, or has been invited to the teleconference but has declined the invitation. These types of satisfaction may be regarded as “constructive disconnections,” for example, insofar as the selected individual never actually connected to the teleconference. As such, various embodiments implementing this join condition can evaluate such constructive disconnections as well as actual disconnections. After the selected individual has disconnected from the teleconference, constructively or otherwise, then the join condition has been satisfied and the potential participant is joined to the teleconference.

In another embodiment, a potential participant, such as person 112b, can establish a join condition requiring that a selected individual has connected to a teleconference session and that the selected individual is prepared for participation in media sharing during the teleconference session before person 112b is joined to the teleconference session. For example, the selected individual can be an individual named by person 112b in the join condition, and the media sharing can include screen sharing. The selected individual might be selected because, for example, person 112b would like view screen sharing provided to the teleconference session by the selected individual, or because person 112b would like provide screen sharing to the teleconference session to be viewed by the selected individual, or for a variety of other reasons. In one embodiment, teleconference server 120 can evaluate the join condition as having been satisfied if the selected individual has connected to the teleconference utilizing both telephone 114 and computer 116, such that the selected individual can participate audibly in the teleconference using telephone 114, and can participate in media sharing using computer 116. In another embodiment, teleconference server 120 can evaluate the join condition as having been satisfied if the selected individual has connected to the teleconference utilizing only computer 116, such that the selected individual can both participate audibly in the teleconference and participate in media sharing using computer 116. After the selected individual has connected to the teleconference and is prepared for participation in media sharing during the teleconference, then the join condition has been satisfied and the potential participant is joined to the teleconference.

In another embodiment, a potential participant, such as person 112b, can establish a join condition requiring that selected information has been expressed during a teleconference session before person 112b is joined to the teleconference session. In this embodiment, the selected information can include information pertaining to a selected topic. For example, the selected topic could include an individual's name, a title of a company report displayed by screen sharing, a name of a division of a company, a phrase that might be spoken in a conversation about a potential employee's hire, or any other selected topic provided in the join condition by person 112b. Person 112b might be motivated to establish a join condition of this kind based on his or her personal or professional interest in the selected topic, for example. Teleconference server 120 can utilize a speech recognition system or a media analysis system to determine the selected topic during a teleconference session. For example, the speech recognition system can include an automatic speech recognition system, a computer speech recognition system, a speech to text system, or another system that converts spoken, audible conversation into text data. The speech recognition system of teleconference server 120 can continually listen to the common audio channel of an ongoing teleconference to recognize spoken words and phrases for comparison to the selected topic in the join condition. For further example, the media analysis system can include an automatic text and picture recognition system, a screen-scraping program, or another system that converts common media channel information into text data suitable for join condition evaluation. The media analysis system of teleconference server 120 can continually observe the common media channel of an ongoing teleconference to recognize textual or pictured words and phrases for comparison to the selected topic in the join condition. Teleconference server 120 can evaluate the join condition as having been satisfied if the identified words and phrases match the selected topic provided in the join condition.

In this embodiment, the selected information can also include information identifying a selected emotional tone. For example, a selected emotional tone could include anger, levity, sadness, or any other emotional tone provided in the join condition by person 112b. Person 112b might be motivated to establish a join condition of this kind based on his or her desire to intervene in a teleconference only if its vocal conversation or shared media becomes emotionally negative or angry, for example. Teleconference server 120 can utilize a sentiment analysis system to identify the selected emotional tone. For example, the sentiment analysis system can determine the attitude of a speaker or writer with respect to some topic or the overall contextual polarity of one or multiple speakers or media sharers of the teleconference. The attitude may be the speaker's or writer's judgment or evaluation, affective state, or the intended emotional communication the speaker or writer wishes to have on another teleconference participant, for example, as indicated by the choice of words made by the speaker or writer, or the speaker's cadence, tone, or volume. The sentiment analysis system of teleconference server 120 can continually listen to an ongoing teleconference common audio channel to identify audible indicia of emotional tones, or can continually monitor an ongoing teleconference common media channel to identify media indicia of emotional tones. Teleconference server 120 can evaluate the join condition as having been satisfied if the identified audible indicia or media indicia match the selected emotional tone provided in the join condition. Whether the selected information is information pertaining to a selected topic, or information identifying a selected emotional tone (or both), after the selected information has been expressed during a teleconference session, then the join condition has been satisfied and the potential participant is joined to the teleconference.

In another embodiment, a potential participant, such as person 112b, can establish a join condition requiring that the potential participant has finished a task that overlaps in time with a teleconference session before person 112b is joined to the teleconference session. For example, the task can be a phone call of person 112b, or a calendared meeting of person 112b, that is put into the join condition by person 112b. If the task is a phone call or calendared meeting that is scheduled to overlap in time with the teleconference session, person 112b would like to join the teleconference only after the phone call or calendared meeting has ended. In one case, teleconference system 120 can determine that a phone call has finished by monitoring telephone 114b to determine when its phone line signal changes from busy to free. In another case, teleconference system 120 can determine that a calendared meeting has finished as of the time when the calendared meeting is scheduled to end, according to the join condition. As an alternative, teleconference system 120 can determine that the calendared meeting has finished only after interacting with the calendaring software of person 112b on computer 116b during the ongoing teleconference. As such, teleconference system 120 can update the information in the join condition with new information from the calendaring software, such that if the calendared meeting is shortened, lengthened, cancelled, or rescheduled after person 112b sets the join condition and before the beginning of the teleconference session (or before the originally scheduled ending of the calendared meeting), the change will be considered by teleconference system 120 while evaluating the join condition. In any case, teleconference server 120 can evaluate the join condition as having been satisfied if the potential participant has finished the phone call, the calendared meeting, or any other concurrent event in the join condition that overlaps in time with the teleconference session. After the potential participant has finished the task that overlaps in time with the teleconference session, then the join condition has been satisfied and the potential participant is joined to the teleconference.

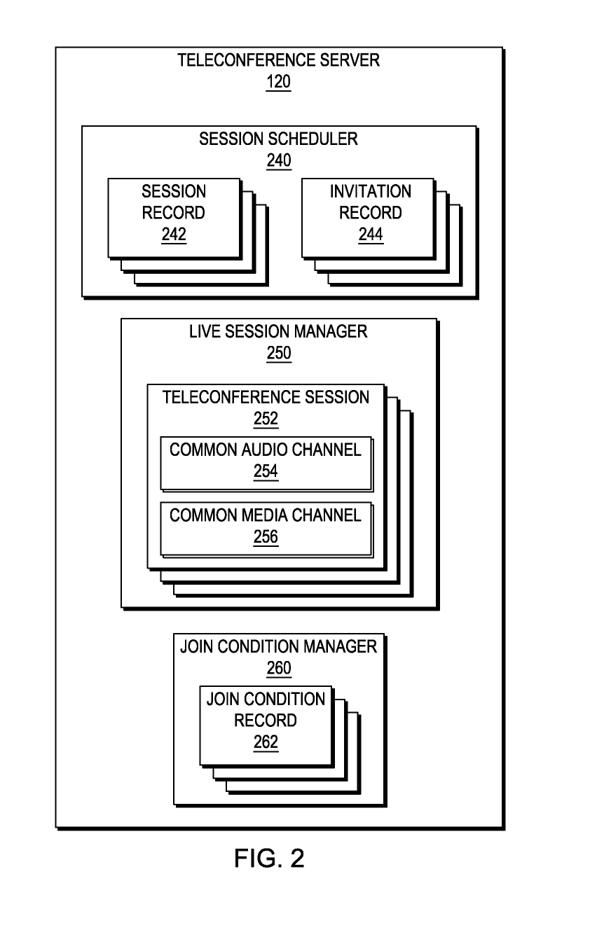

FIG. 2 depicts a functional block diagram of teleconference server 120 in accordance with an illustrative embodiment of the present invention. Teleconference server 120 includes session scheduler 240, live session manager 250, and join condition manager 260. Session scheduler 240, which includes session records 242 as well as invitation records 244, manages scheduled teleconferences and invitations in coordination with the calendaring software of computers 118a through 118n shown in FIG. 1. Live session manager 250 includes teleconference sessions 252, each of which includes a common audio channel 254 and common media channel 256, and handles overhead and coordination for active, ongoing teleconference sessions 252. Join condition manager 260, which includes join condition records 262, evaluates join conditions before and during active, ongoing teleconference sessions 252.

Teleconference server 120 is interoperable with calendaring software of computers 116a through 116n, at least for the purpose of scheduling teleconferences. Such scheduled teleconferences are stored as session records 242, for set-up and operation as ongoing, active teleconference sessions 252. If person 112a uses computer 116a to select a date and time for a teleconference, this selection can be recorded in session records 242, and if person 112a uses computer 116a to send invitations or notifications to persons 112b through 112n that inform them of the teleconference and request their participation, these invitations can be recorded and updated as invitation records 244. In another embodiment, teleconference server 120 can send and manage invitations. In one embodiment, the calendaring software is provided from teleconference server 120 to computers 116a through 116n via a web interface, for example, such that session scheduler 240 can be manipulated by persons 112a through 112n.

Teleconference server 120 establishes active, ongoing teleconference sessions 252 on the scheduled date and time, stored in session records 242, for the appropriate participants. Each teleconference session 252 includes one or both of common audio channel 254 and common media channel 256. Common audio channel 254 includes, in one embodiment, hardware and software for conveying audio information among teleconference participants, and common media channel 256 includes, in one embodiment, hardware and software for conveying visual or other media information among teleconference participants. In one embodiment, teleconference server 120 can establish teleconference session 252 by making available common audio channel 254 to telephones 114a through 114n, or to computers 116a through 116n, which persons 112a through 112n utilize by dialing a phone number or by activating teleconference client software, respectively. In other embodiments, teleconference server 120 can establish teleconference session 252 by opening common audio channel 254 among telephones 114a through 114n by automatically dialing telephones 114a through 114n, or by automatically activating teleconference client software of computers 116a through 116n. In addition to providing common audio channel 254, teleconference server 120 can also provide common media channel 256, which may be a common visual channel, in the case of screen or slide sharing facilitated by computers 116a through 116n, for example. Further, in one embodiment, teleconference server 120 can provide a common data channel that combines audio, media, and other information into a single common channel.

In addition to establishing teleconference sessions 252 on the scheduled date and time for the appropriate participants as discussed above, teleconference server 120 also evaluates join conditions stored in join condition records 262 before and during teleconference sessions 252. In one embodiment, person 112b can establish a join condition for a scheduled teleconference stored in session records 242 utilizing join condition software on computer 116b, and once established on computer 116b the join condition is sent to teleconference server 120 via network 130 for storage in join condition records 262 and for evaluation before or during a teleconference session 252.

Evaluation of a join condition stored in join condition records 262 by join condition manager 260 involves examining information in the environment of a potential participant, or examining information stored in session records 242, invitation records 244, or in teleconference session 252, for example. If a join condition evaluation results in a determination that the potential participant should be joined to the teleconference, then the joining can be accomplished in several ways. For example, teleconference server 120 can join the potential participant to the teleconference by calling telephone 114 of the potential participant, or by sending the potential participant an email or other electronic notification that the join condition has been satisfied on his or her computer 116, for example. A variety of join conditions discussed above, in the discussion of FIG. 1, are discussed again below, in relation to FIG. 2. One or more of the following join conditions can be implemented in any given embodiment

In one embodiment, a join condition created by a potential participant and stored in join condition records 262 requires that a selected number of individuals necessary to establish a quorum has connected to teleconference session 252, before the potential participant is joined to teleconference session 252. To evaluate the join condition, join condition manager 260 can periodically count the total number of participants who have joined teleconference session 252, or count the number of company officers or directors who have joined teleconference session 252, for example. In the former case, the total number of participants is readily evident to join condition manager 260, based on, for example, the total number of participants listening to common audio channel 254. In the latter case join condition manager 260 can be configured to have access to a personnel directory or organizational chart, to learn which participants in teleconference session 252 are company officers or directors. Alternatively, in the latter case join condition manager 260 can learn which participants in teleconference session 252 are company officers or directors from the person who set up teleconference session 252, as recorded in a corresponding session record 242, for example, or from a status indication in each participant's invitation acceptance or rejection as recorded in corresponding invitation records 244. After the counted number of company officers or directors or of total participants reaches or exceeds the defined quorum level, then join condition manager 260 determines that the join condition has been satisfied and joins the potential participant to teleconference session 252.

In another embodiment, a join condition created by a potential participant and stored in join condition records 262 requires that a selected individual has disconnected from teleconference session 252 before the potential participant is joined to teleconference session 252. In one embodiment, join condition manager 260 can evaluate the join condition as having been satisfied if the selected individual has connected to teleconference session 252 and then disconnected. In another embodiment, join condition manager 260 can evaluate the join condition as having been satisfied if the selected individual has not been invited to teleconference session 252, or has been invited to teleconference session 252 but has declined the invitation, as recorded in corresponding invitation records 244. These types of satisfaction may be regarded as “constructive disconnections,” for example, insofar as the selected individual never actually connects to teleconference session 252. After the selected individual has disconnected from teleconference session 252, constructively or otherwise, then join condition manager 260 determines that the join condition has been satisfied and joins the potential participant to teleconference session 252.

In another embodiment, a join condition created by a potential participant and stored in join condition records 262 requires that a selected individual has connected to teleconference session 252 and that the selected individual is prepared for participation in media sharing (via common media channel 256, for example) during teleconference session 252 before the potential participant is joined to teleconference session 252. In one embodiment, join condition manager 260 can evaluate the join condition as having been satisfied if the selected individual has connected to teleconference session 252 utilizing both telephone 114 and computer 116, such that the selected individual can participate audibly in teleconference session 252 using telephone 114, and can participate in media sharing using computer 116 (via, respectively, common audio channel 254 and common media channel 256, for example). In another embodiment, join condition manager 260 can evaluate the join condition as having been satisfied if the selected individual has connected to teleconference session 252 utilizing only computer 116, such that the selected individual can both participate audibly in teleconference session 252 and participate in media sharing using computer 116 (via, respectively, common audio channel 254 and common media channel 256, for example). After the selected individual has connected to teleconference session 252 and is prepared for participation in media sharing during teleconference session 252, then the join condition has been satisfied and the potential participant is joined to teleconference session 252.

In another embodiment, a join condition created by a potential participant and stored in join condition records 262 requires that selected information has been expressed during teleconference session 252 before the potential participant is joined to teleconference session 252. In this embodiment, the selected information can include information pertaining to a selected topic. Join condition manager 260 can utilize a speech recognition system to determine the selected topic during teleconference session 252. The speech recognition system can continually listen to common audio channel 254 of teleconference session 252 to recognize spoken words and phrases for comparison to the selected topic in the join condition. Join condition manager 260 can evaluate the join condition as having been satisfied if the identified words and phrases match the selected topic provided in the join condition. In this embodiment, the selected information can also include information identifying a selected emotional tone. Join condition manager 260 can utilize a sentiment analysis system to identify the selected emotional tone. The sentiment analysis system of join condition manager 260 can continually listen to common audio channel 254 or monitor common media channel 256 to identify audible or media indicia of emotional tones. Join condition manager 260 can evaluate the join condition as having been satisfied if the identified audible or media indicia match the selected emotional tone provided in the join condition. After the selected information has been expressed during teleconference session 252, then the join condition has been satisfied and the potential participant is joined to teleconference session 252.

In another embodiment, a join condition created by a potential participant and stored in join condition records 262 requires that the potential participant has finished a task that overlaps in time with teleconference session 252 before the potential participant is joined to teleconference session 252. Join condition manager 260 can evaluate the join condition as having been satisfied if the potential participant has finished a phone call, calendared meeting, or any other concurrent event in the join condition that overlaps in time with teleconference session 252. After the potential participant has finished the task that overlaps in time with teleconference session 252, then the join condition has been satisfied and the potential participant is joined to teleconference session 252.

Accordingly, persons 112a through 112n can create and customize many different join conditions in accordance with desired embodiments of the present invention. The join conditions discussed above can be implemented alone or in combination with other join conditions.

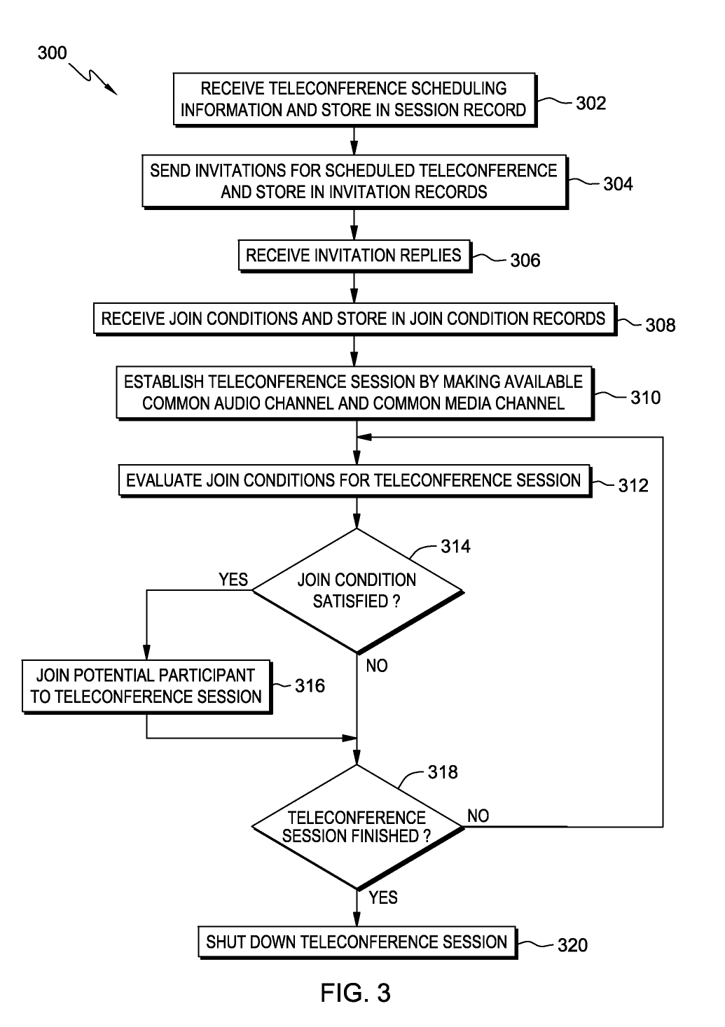

FIG. 3 depicts flowchart 300, which illustrates steps followed by teleconference server 120 to establish teleconference sessions and evaluate join conditions in accordance with an embodiment of the present invention. In step 302, teleconference server 120 receives teleconference scheduling information and stores it in session records 242. The teleconference scheduling information can be received from, for example, calendaring software on a computer 116 of the person 112 who is scheduling the teleconference. In step 304, teleconference server 120 sends invitations for the scheduled teleconference and stores records of the invitations in invitation records 244. In another embodiment, the computer 116 used to send teleconference scheduling information can also send out the invitations, rather than teleconference server 120. In step 306, teleconference server 120 receives invitation replies. The replies to the invitations can be used to update invitation records 244 by, for example, changing an invitation record 244 to indicate that an invited participant has accepted or declined the invitation. The replies to the invitations can also be used to update session record 242 to indicate, for example, that an invited participant has declined an invitation and should no longer be joined to teleconference session 252 when it is established, or to indicate that an invited participant has updated contact information at which he or she should be contacted when teleconference session 252 is established. In step 308, teleconference server 120 receives join conditions from, for example, computers 116a through 116n and stores them in join condition records 262. The join conditions can include some or all of the join conditions described above, and can include other join conditions not discussed above but within the scope of the present invention.

In step 310, teleconference server 120 establishes teleconference session 252 by making available common audio channel 254, or common media channel 256, or both. For example, teleconference server 120 can make these available by contacting the participants using contact information stored in session records 242 or by waiting for the participants to dial in or otherwise connect to teleconference server 120. In one embodiment, potential participants who have created join conditions will not be joined to teleconference session 252 in step 310, and instead will be joined later if their respective join conditions are satisfied. However, in another embodiment, teleconferences server 120 nevertheless sends such potential participants a reminder that teleconference session 252 is starting, in case the potential participant desires to cancel his or her join condition and join teleconference session 252 immediately. Further still, in another embodiment, potential participants are partially joined to teleconference session 252 at its beginning, such that they can, for example, have the option to merely observe shared media or listen, while muted. In such an embodiment, the potential participants remain only partially joined until their respective join conditions are satisfied, if ever.

In step 312, teleconference server 120 begins evaluating join conditions for teleconference session 252 as, for example, join condition manager 260 periodically or continuously examines information in the environment of a potential participant, or examines information stored in session records 242, invitation records 244, or in teleconference session 252. If teleconference server 120 determines in step 314 that a join condition is satisfied, then in step 316 the respective potential participant is joined to teleconference session 252 as an active participant, and in step 318 teleconference server 120 determines if teleconference session 252 is still ongoing. However, if teleconference server 120 determines in step 314 that a join condition is not satisfied, then no potential participant is joined and in step 318 teleconference server 120 determines if teleconference session 252 is still ongoing. If in step 318 teleconference server 120 determines that teleconference session 252 is finished, then in step 320 teleconference server 120 shuts down teleconference session 252. For example, teleconference session 252 may be finished when all active participants have disconnected from common audio channel 254, for example, and teleconference session 252 may be shut down by, for example, having live session manager 250 teardown any applicable common audio channel 254 and common media channel 256. If in step 318 teleconference server 120 determines that teleconference session 252 is not finished, then step 312 is repeated and an additional evaluation of join conditions is performed.

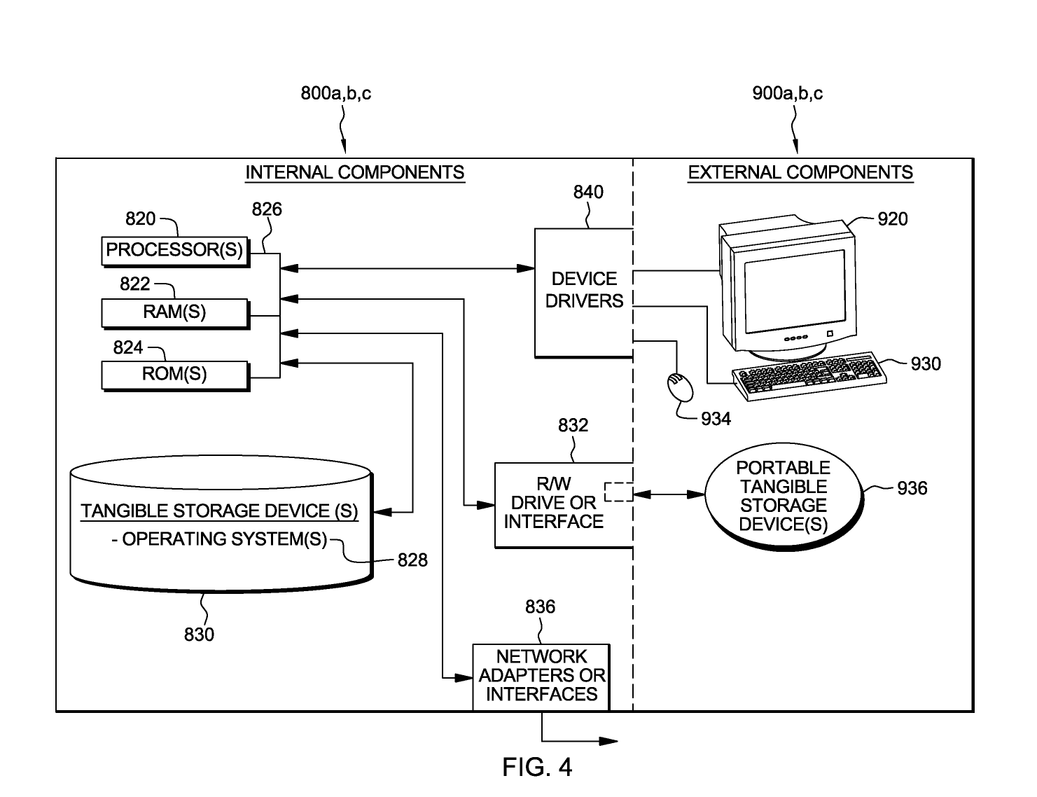

FIG. 4 shows a block diagram of the components of a data processing system 800, 900, such as teleconference server 120 or any of computers 116, in accordance with an illustrative embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

Data processing system 800, 900 is representative of any electronic device capable of executing machine-readable program instructions. Data processing system 800, 900 may be representative of a smart phone, a computer system, a PDA, or other electronic devices. Examples of computing systems, environments, and/or configurations that may represented by data processing system 800, 900 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

Teleconference server 120 or any of computers 116 include respective sets of internal components 800 a, b, c and external components 900 a, b, c illustrated in FIG. 4. Each of the sets of internal components 800 a, b, c includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828; session scheduler 240, live session manager 250, and join condition manager 260 in teleconference server 120; and the calendaring software of computers 116 are stored on one or more of the respective computer-readable tangible storage devices 830 for execution by one or more of the respective processors 820 via one or more of the respective RAMs 822 (which typically include cache memory). In the embodiment illustrated in FIG. 4, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800 a, b, c also includes a RAW drive or interface 832 to read from and write to one or more portable computer-readable tangible storage devices 936 such as a CD-ROM, DVD, memory stick, magnetic tape, magnetic disk, optical disk or semiconductor storage device. Session scheduler 240, live session manager 250, and join condition manager 260 in teleconference server 120; and the calendaring software of computers 116 can be stored on one or more of the respective portable computer-readable tangible storage devices 936, read via the respective RAW drive or interface 832 and loaded into the respective hard drive 830.

Each set of internal components 800 a, b, c also includes network adapters or interfaces 836 such as a TCP/IP adapter cards, wireless wi-fi interface cards, or 3G or 4G wireless interface cards or other wired or wireless communication links. Session scheduler 240, live session manager 250, and join condition manager 260 in teleconference server 120, as well as the calendaring software of computers 116 can be downloaded to respective teleconference server 120 or computers 116 from an external computer via a network (for example, the Internet, a local area network or other, wide area network) and respective network adapters or interfaces 836. From the network adapters or interfaces 836, session scheduler 240, live session manager 250, and join condition manager 260 in teleconference server 120, as well as the calendaring software of computers 116 are loaded into the respective hard drive 830. The network may comprise copper wires, optical fibers, wireless transmission, routers, firewalls, switches, gateway computers and/or edge servers.

Each of the sets of external components 900 a, b, c can include a computer display monitor 920, a keyboard 930, and a computer mouse 934. External components 900 a, b, c can also include touch screens, virtual keyboards, touch pads, pointing devices, and other human interface devices. Each of the sets of internal components 800 a, b, c also includes device drivers 840 to interface to computer display monitor 920, keyboard 930 and computer mouse 934. The device drivers 840, RAW drive or interface 832 and network adapter or interface 836 comprise hardware and software (stored in storage device 830 and/or ROM 824).

Aspects of the present invention have been described with respect to block diagrams and/or flowchart illustrations of methods, apparatus (system), and computer program products according to embodiments of the invention. It will be understood that each block of the flowchart illustrations and/or block diagrams, and combinations of blocks in the flowchart illustrations and/or block diagrams, can be implemented by computer instructions. These computer instructions may be provided to a processor of a general purpose computer, special purpose computer, or other programmable data processing apparatus to produce a machine, such that instructions, which execute via the processor of the computer or other programmable data processing apparatus, create means for implementing the functions/acts specified in the flowchart and/or block diagram block or blocks.

The aforementioned programs can be written in any combination of one or more programming languages, including low-level, high-level, object-oriented or non object-oriented languages, such as Java, Smalltalk, C, and C++. The program code may execute entirely on the user's computer, partly on the user's computer, as a stand-alone software package, partly on the user's computer and partly on a remote computer, or entirely on a remote computer or server. In the latter scenario, the remote computer may be connected to the user's computer through any type of network, including a local area network (LAN) or a wide area network (WAN), or the connection may be made to an external computer (for example, through the Internet using an Internet service provider). Alternatively, the functions of the aforementioned programs can be implemented in whole or in part by computer circuits and other hardware (not shown).

Based on the foregoing, computer system, method and program product have been disclosed in accordance with the present invention. However, numerous modifications and substitutions can be made without deviating from the scope of the present invention. Therefore, the present invention has been disclosed by way of example and not limitation. The foregoing description of various embodiments of the present invention has been presented for purposes of illustration and description. It is not intended to be exhaustive nor to limit the invention to the precise form disclosed. Many modifications and variations are possible. Such modifications and variations that may be apparent to a person skilled in the art of the invention are intended to be included within the scope of the invention as defined by the accompanying claims.

What is claimed is:

1. A computer-implemented method comprising the steps of:
receiving a join condition of a potential participant of a real-time collaboration session, wherein the join condition requires that a selected individual has disconnected from the real-time collaboration session, requires that a selected number of individuals necessary to establish a quorum has connected to the real-time collaboration session, requires that the selected individual has connected to the real-time collaboration session and that the selected individual is prepared for participation in media sharing during the real-time collaboration session, requires that selected information has been expressed during the real-time collaboration session, or requires that the potential participant has finished a task that overlaps in time with the real-time collaboration session;
determining that the join condition has been satisfied; and
responsive to the determining, notifying the potential participant to join the real-time collaboration session.

2. The method of claim 1, wherein the selected individual has disconnected from the real-time collaboration session by an actual disconnection.

3. The method of claim 1, wherein the selected individual has disconnected from the real-time collaboration session by a constructive disconnection.

4. The method of claim 1, wherein the quorum is a majority of officers or directors who have been invited to the real-time collaboration session, or is a majority of the total participants who have been invited to the real-time collaboration session.

5. The method of claim 1, wherein the participation in media sharing during the real-time collaboration session includes providing screen sharing to the real-time collaboration session.

6. The method of claim 1, wherein the participation in media sharing during the real-time collaboration session includes receiving screen sharing from the real-time collaboration session.

7. The method of claim 1, wherein the selected information that has been expressed includes information pertaining to a selected topic.

8. The method of claim 7, wherein a determination that selected information has been expressed is made by a speech recognition system or a media analysis system.

9. The method of claim 1, wherein the selected information that has been expressed includes information identifying a selected emotional tone.

10. The method of claim 1, wherein the task that overlaps in time with the real-time collaboration session includes a phone call of the potential participant, or includes a calendared meeting of the potential participant.

11. A computer program product comprising:
one or more computer-readable tangible storage devices and program instructions stored on at least one of the one or more storage devices, the program instructions comprising:
program instructions to receive a join condition of a potential participant of a real-time collaboration session, wherein the join condition requires that a selected individual has disconnected from the real-time collaboration session, requires that a selected number of individuals necessary to establish a quorum has connected to the real-time collaboration session, requires that the selected individual has connected to the real-time collaboration session and that the selected individual is prepared for participation in media sharing during the real-time collaboration session, requires that selected information has been expressed during the real-time collaboration session, or requires that the potential participant has finished a task that overlaps in time with the real-time collaboration session;
program instructions to determine that the join condition has been satisfied; and
program instructions to, responsive to the determining, notify the potential participant to join the real-time collaboration session.

12. The computer program product of claim 11, wherein the selected individual has disconnected from the real-time collaboration session by an actual disconnection.

13. The computer program product of claim 11, wherein the selected individual has disconnected from the real-time collaboration session by a constructive disconnection.

14. The computer program product of claim 11, wherein the quorum is a majority of officers or directors who have been invited to the real-time collaboration session, or is a majority of the total participants who have been invited to the real-time collaboration session.

15. The computer program product of claim 11, wherein the participation in media sharing during the real-time collaboration session includes providing screen sharing to the real-time collaboration session.

16. The computer program product of claim 11, wherein the participation in media sharing during the real-time collaboration session includes receiving screen sharing from the real-time collaboration session.

17. The computer program product of claim 11, wherein the selected information that has been expressed includes information pertaining to a selected topic.

18. The computer program product of claim 11, wherein the selected information that has been expressed includes information identifying a selected emotional tone.

19. The computer program product of claim 11, wherein the task that overlaps in time with the real-time collaboration session includes a phone call of the potential participant, or includes a calendared meeting of the potential participant.

20. A system comprising:
one or more processors, one or more computer-readable memories, one or more computer-readable tangible storage devices, and program instructions stored on at least one of the one or more storage devices for execution by at least one of the one or more processors via at least one of the one or more memories, the program instructions comprising:
program instructions to receive a join condition of a potential participant of a real-time collaboration session, wherein the join condition requires that a selected individual has disconnected from the real-time collaboration session, requires that a selected number of individuals necessary to establish a quorum has connected to the real-time collaboration session, requires that the selected individual has connected to the real-time collaboration session and that the selected individual is prepared for participation in media sharing during the real-time collaboration session, requires that selected information has been expressed during the real-time collaboration session, or requires that the potential participant has finished a task that overlaps in time with the real-time collaboration session;
program instructions to determine that the join condition has been satisfied; and
program instructions to, responsive to the determining, notify the potential participant to join the real-time collaboration session.
